(19) United States
(12) Patent Application Publication
(10) Pub. No.: US 2005/0079249 A1
(43) Pub. Date: Apr. 14, 2005

(54) Sandwich packaging

(76) Inventor: Brian Peters, Rustington (GB)

Correspondence Address: Paul Grandinetti;Levy & Grandinetti, Suite 1108, 1725 K Street, N.W., Washington, DC, 20006-1423, US

(21) Appl. No.: 10/683,456

(22) Filed: Oct. 14, 2003

(51) Int. Cl. C12C 1/027

(52) U.S. Cl. 426/106

(57) ABSTRACT

Packaging for food comprising a body portion adapted to contain the food, an opening, and an external wrapping, in which the body portion is provided with extension elements adapted to prevent the external wrapping contacting the food through the opening.

This invention relates to a food packaging system, particularly, but not exclusively for packaging sandwiches.

Sandwiches are a popular fast food widely sold from various outlets, and are commonly created from two square slices of bread laid on top of one another with a filling spread in between. Most pre-packaged sandwiches are sliced into two triangular pieces and sold in a triangular package. The slices are placed next to one another, with the longest side facing uppermost in the package so the filling can be seen.

Such packages are commonly constructed from a clear plastics material, and may have a paper or cardboard label element contained within the packaging. Various sizes of the package can accommodate two, three or four sandwich slices. However, this kind of packaging must be formed from the plastics material before the food is placed inside it. This results in slow construction of the product because each sandwich has to be placed into the package. Further, this type of packaging may not be recyclable or kind to the environment.

In order to address this problem, it is also known to package sandwiches in a paper or card package, which can be wrapped around the sandwich slices during construction of the product. It is common to construct a triangular package with an open frontage, through which the slices can be removed. The package can be wrapped in film constructed from a clear plastics material.

However, this type of packaging suffers from a particular problem. Due to the structural weakness of the card used, it is common for the plastics film to come into contact with the sandwich slices. If the slices contain a large quantity of filling with a low structural integrity, for example egg and mayonnaise or Coronation chicken, the plastics film can come into contact with the filling. This results in a poor appearance, and an unpleasant filling residue being left on the plastics film when the sandwich is removed for consumption.

The present invention is intended to overcome some of the above problems.

According to the present invention packaging for food comprises a body portion adapted to contain the food, an opening, and an external wrapping, in which the body portion is provided with extension elements adapted to prevent the external wrapping contacting the food through the opening.

Preferably the packaging is for two triangular sandwich slices, and the body portion is substantially triangular in shape. It will be appreciated that the packaging can also be for three or four sandwich slices. The body portion may be a substantially isosceles triangular shape, with one corner being substantially 90 degrees.

The body portion can also be provided with an opening on the longest side of the triangle, through which the sandwich slices can be observed and removed.

Preferably the extension elements comprise elongate flaps which extend from the top and the bottom of the rim around the opening, and over part of the front of the sandwich slices. With this arrangement the external wrapping is held away from the sandwich slices, and the outer ends of the sandwiches are also protected.

In addition, the flaps can be biased away from the opening so the external wrapper is further held away from the sandwich slices, and can be held taught from the edge of one flap to the other.

In one embodiment the body is constructed from cardboard or solid board, and the flaps extend from the rear and lower sections of the body, so that when they are folded over the opening, they are biased away from the opening.

The external wrapping can be constructed from a lightweight and clear plastics material.

The body can be printed with labelling, advertising or colouring, and varnished on the outside face to provide a hard wearing surface. In particular, the extension flaps can also be printed with labelling, advertising or colouring.

Preferably the materials used are of food grade, are FDA approved and can resist an element of ‘fat creep’ from the enclosed sandwich.

The invention can be performed in various ways but one embodiment will now be described by way of example and with reference to the accompanying drawings in which:

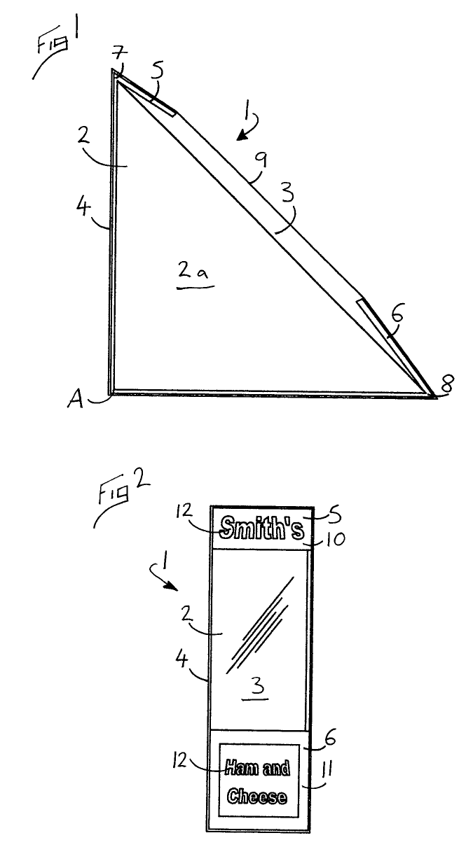

FIG. 1 is a side view of a sandwich pack according to the present invention: and,

FIG. 2 is a front view of the sandwich pack as shown in FIG. 1.

As shown in FIG. 1 a sandwich pack 1 comprises a body portion 2 adapted to contain the sandwiches (not shown) an opening 3, and an external wrapping 4. The body portion 2 is provided with extension elements 5 and 6 adapted to prevent the external wrapping 4 contacting the sandwiches through the opening 3.

The body portion 2 is a substantially isosceles triangle shaped container with one side removed. The corner A is substantially 90 degrees. The body portion 2 is shaped and dimensioned to contain two triangular sandwich slices (not shown) in a sandwich bay area 2a.

Opening 3 is provided at the front of the body 2, and is shaped and dimensioned to allow the slices to be observed and removed for consumption.

The extension elements 5 and 6 are flaps which extend from the top edge 7 and the bottom edge 8 of the opening 3. The flaps 5 and 6 extend over part of the front of the sandwich slices and protect their tops and bottoms. The flaps are biased in an outwards direction away from the sandwich slices.

The external wrapping 4 surrounds the entire body portion 2. As shown in FIG. 1 the flaps 5 and 6 hold the forward facing section 9 of the external wrapping 4 away from the sandwich bay area 2a, and hence away from the sandwich slices (not shown).

Further, the outward biasing of the flaps 5 and 6 holds the forward facing section 9 taught across the opening 3.

The body portion 2 is constructed from cardboard, and the external wrapping 4 is constructed from a clear plastics material film. The cardboard material is food grade, FDA approved and can resist “fat creep”.

As shown in FIG. 2 the front faces 10 and 11 of the flaps 5 and 6 can be printed with labelling 12 or other graphics.

Thus a sandwich package is provided which is readily constructed and made from recyclable materials, which effectively packages the sandwiches without causing them to be damaged or smeared across the external wrapping.

1. Packaging for food comprising a body portion adapted to contain the food, an opening, and an external wrapping, in which the body portion is provided with extension elements adapted to prevent the external wrapping contacting the food through the opening.

2. Packaging as claimed in claim 1 in which the body portion is formed from two spaced apart and substantially isosceles triangle shaped sides, which are connected by two substantially rectangle shaped sides extending between each of the corresponding shorter edges of the triangles, and in which the opening is a rectangular shape defined by the corresponding longer edges of the triangles shaped sides and the corresponding shorter edges of the rectangle shaped sides.

3. Packaging as claimed in claim 2 in which the extension elements extend from the shorter edges of the rectangle shaped sides which define the opening, and in which the extension elements are biased away from the opening.

4. Packaging as claimed in claim 3 in which the body is formed from a single piece of card board material, and in which the extension elements are biased away from the opening by being folded in relation to the rectangular shaped sides to an angle less than the angle of the adjacent corner of the triangle.

5. Packaging as claimed in claim 4 in which the external wrapping is constructed from a clear plastics material.

6. Packaging as claimed in claim 1 in which the body is adapted to contain sandwiches.
